(19) United States
(12) Patent Application Publication
(10) Pub. No.: US 2008/0244725 A1
(43) Pub. Date: Oct. 2, 2008

(54) METHOD AND APPARATUS FOR MANAGING PACKET BUFFERS

(76) Inventors: Prashant Dewan, Hillsboro, OR (US); Uday Savagaonkar, Hillsboro, OR (US); Hormuzd M. Khosravi, Portland, OR (US)

Correspondence Address: SCHWEGMAN, LUNDBERG & WOESSNER, P.A., P.O. BOX 2938, MINNEAPOLIS, MN, 55402, US

(21) Appl. No.: 11/695,016

(22) Filed: Mar. 31, 2007

(51) Int. Cl. G06F 21/00

(52) U.S. Cl. 726/13

(57) ABSTRACT

According to one example embodiment of the inventive subject matter, there is described herein a method and apparatus for securely and efficiently managing packet buffers between protection domains on an Intra-partitioned system using packet queues and triggers. According to one embodiment described in more detail below, there is provided a method and apparatus for optimally transferring packet data across contexts (protected and unprotected) in a commodity operating system.

### TECHNICAL FIELD

Various embodiments described herein relate to computing technology generally, including method and apparatus for managing packet buffers.

### BACKGROUND

Intra-Partitioning is a security architecture that leverages virtualization technology to protect critical software agents from other components of the same operating system.

### BRIEF DESCRIPTION OF THE DRAWINGS

FIG. 1 is a block diagram of a system illustrating an Intra-Partitioning architecture according to various embodiments of the invention.

FIG. 2 is a block diagram illustrating a system and method for packet handling according to various embodiments of the invention.

FIG. 3 is a flow diagram illustrating packet handling according to various embodiments of the invention.

FIG. 4 is a block diagram of an article according to various embodiments of the invention.

### DETAILED DESCRIPTION

According to one example embodiment of the inventive subject matter, there is described herein a method and apparatus for securely and efficiently managing packet buffers between protection domains on an Intra-partitioned system using packet queues and triggers. According to one embodiment described in more detail below, there is provided a method and apparatus for optimally transferring packet data across contexts (protected and unprotected) in a commodity operating system, for example but not by way of limitation, one running on the Intel® Virtualization Technology (VT) based platform, available from Intel Corporation.

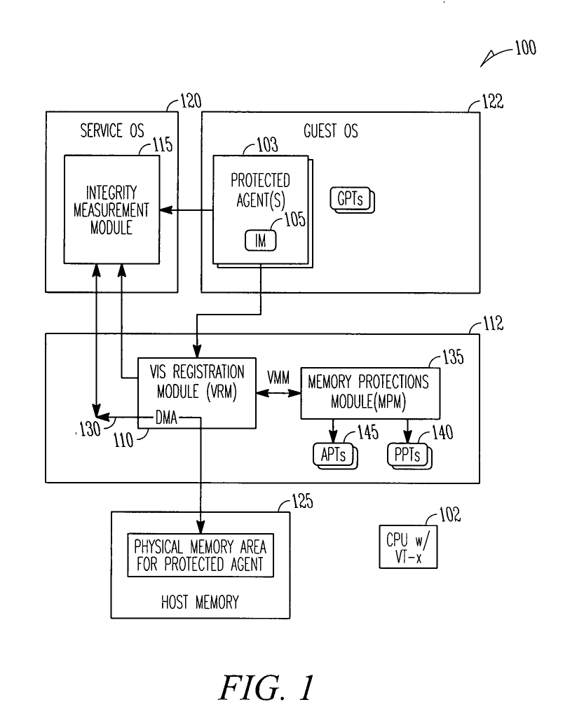

FIG. 1 shows an overview of the architecture of an Intra-Partitioning system 100, executing on a processing unit 102 having, for example, the VT architecture. Intra-Partitioning is a security architecture that leverages the Intel VT architecture to protect critical software agents running inside a Guest Operating System (GOS) 122, including Guest Page Tables (GPTs) 123, from other components of the same operating system. Intra-Partitioning performs three main roles interacting among various modules.

Intra-Partitioning first verifies the integrity of the agent 103 that needs to be protected. The pristine attributes of the agent are identified with its corresponding Integrity Manifest (IM) 105 that is cryptographically signed and describes how the agent looks like when it is loaded into memory. When the agent is loaded and starts executing, it sends registration request to Intra-Partitioning Registration Module (VRM) 110 of Virtualization Machine Monitor (VMM) 112. VRM 110 forwards this request along with the agent's IM 105 to the Integrity Measurement Module (IMM) 115 that typically resides in a separate isolated partition such as the Service OS 120. IMM 115 goes through the host physical memory 125 corresponding to the agent's code and data using direct memory access (DMA) 130 and validates the agent by comparing the loaded memory image with the IM 105.

Second, once integrity verification is complete, the VRM 110 signals the Memory Protections Module (MPM) 135 to set up the runtime memory protection for the agent. MPM 135 creates a new set of page table, called Protected Page Table (PPT) 140 and moves the linear address space corresponding to the protected agent's code and data from the Active Page Table (APT) 145 to PPT 140. Basically, the MPM 135 enforces separation between these two address spaces that are represented by APT 145 and PPT 140. By adjusting the page table base address register (CR3) to APT 145 or PPT 140 only when it is allowed upon page faults, the runtime memory protection for the agent is achieved. From that point on, every transition across protection boundaries generates a code or data page fault.

Third, as a part of performance optimization, code page faults in the network stack are minimized by accumulating caused by the dynamically allocated data that is accessed in both protected and unprotected code and invoking the Unprotected Code Module (UCM) (not shown in FIG. 1) only on certain triggers. The UCM runs in the memory of the Guest Operating System (GOS) 122. As part of one example embodiment of the inventive subject matter described below, more details on an algorithm for packet management and, the UCM are described below.

Thus, the VT-based Intra Partitioning partitions a platform and thereby compartmentalizes memory areas to protect them from each other. In this technology, a process's linear address space is partitioned into protected and unprotected partitions named as micro-contexts. The access across these partitions is tightly controlled by the underlying VMM 112 by means of strict enforcement of policies. For example such policies may allow protected data reads only, for unprotected code or disallow jumps from unprotected to protected sections except at legitimate entry points.

In the TCP/IP network stack a packet flows through different layers of functionality before going on to the wire. In VT-based Intra Partitioning, a protected section is created that encompasses the Network Interface Card (NIC) driver and the PCI/PCIe registers, such that when a packet enters a protected section, it cannot be maliciously modified. This protected section is used for secure packet inspection and/or manipulation in the protected domain. As a result, all the packets traversing the TCP/IP network stack have to go across the boundary that separates the protected and the unprotected domains. One technique to do this is to let each packet traverse the boundary, leading to a page fault and a corresponding exit event, referred to herein as VMExits but not by way of limitation, for every packet. This approach may negatively affect throughput as it may increase CPU utilization overhead due to the cost of VMExits. VT Integrity Services for Networking (VISN), for example based on the Intel® VT architecture, creates isolated partitions in a commodity operating system to protect code and data sections for drivers in the Operating System (OS). VISN defines a framework for measuring the integrity of software agents running on virtualized (VT based) platforms as well as enforcing protections for these agents using memory firewall functionality that is built into the VMM.

According to one example embodiment of the inventive subject matter described in more detail below, improvement in performance is obtained at least in part by reducing the number of VMExits. According to one implementation, on the send path, the packets are intercepted just before they enter the NIC miniport driver and collected in a common buffer. On certain predefined events, the common buffer is passed to the protected code, where the protected code process all packets in the buffer together, and returns them to the unprotected code. As a result, the number of traversals across the protected/unprotected boundary is significantly reduced leading to reduction in the number of VMExits, resulting in lower CPU Utilization. This mechanism may reduce the CPU utilization overhead of VT based protection of a driver (over LVMM) by a significant factor and may bring it even below the VMM CPU Utilization. On the receive path, the packets may be intercepted as soon as they are copied onto the ring buffer by the NIC and the set of packets is sent to the OS stack. According to one embodiment, the above mechanism does not need any modification to the NIC driver or the OS Stack or any other OS component. All the logic is added to an Intermediate driver that sits between the protocol stack and the NIC driver.

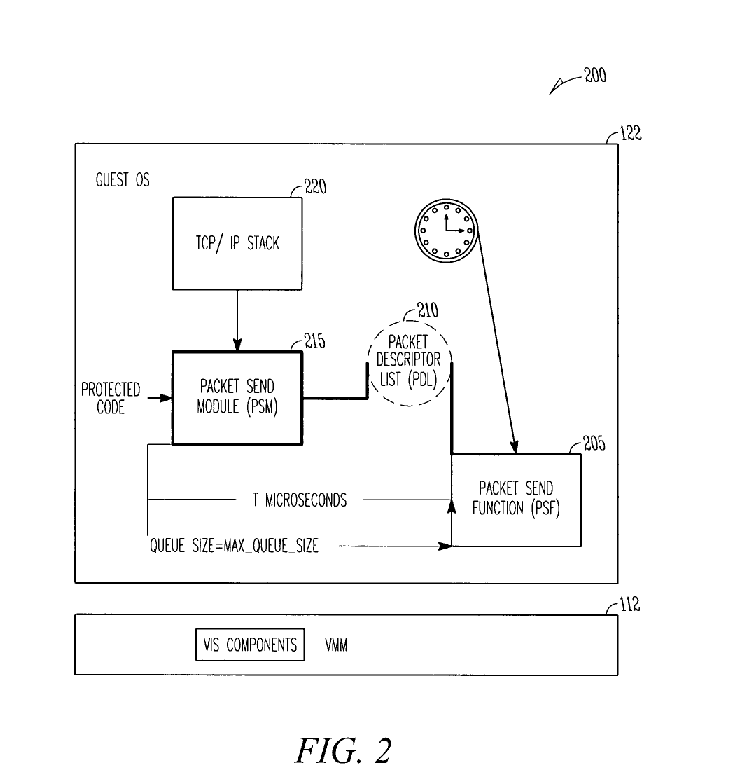

Referring now to the system and method of FIG. 2, there is described an example mechanism to minimize the code transitions from the unprotected to the protected region and vice versa. In this embodiment, there is employed a Packet Send Function (PSF) 205, a Packet Descriptor List (PDL) 210 in which all the packets are cached, and a Packet Send Module (PSM) 215 that sends all the packets from the shared buffer onto the wire after validating them. Further, there is provided, in one example embodiment but not by way of limitation, three static trigger mechanisms that trigger the PSM 215.

The PSF 205 receives all the packets from the upper layers of the TCP/IP stack 220. The packets are identified by a descriptor that has pointers to the packet buffers. A packet might be in a single contiguous buffer or in multiple non contiguous buffers. The PSF 205 creates the PDL 210 and keeps on adding to the list till one of the triggers are fired.

The PDL 210 is a queue of packets maintained in the link layer of the stack. As the packet is received by the link layer, all the buffers from the descriptor received are extracted and copied on to a page aligned shared memory. The packets are only sent to the lower layer when one of the three preconfigured triggers is fired. The PDL 210 is accessed by the PSF 205 for adding packets and the PSM 215 for removing packets. These accesses are synchronized using spin locks.

The PSM 215 takes the page aligned buffer and sends all the packets in buffer to the wire. The PSM 215 contains the protected functions that check the integrity and the validity of the packet. PSM 215 might be completely protected or only certain sections of the PSM 215 may be protected.

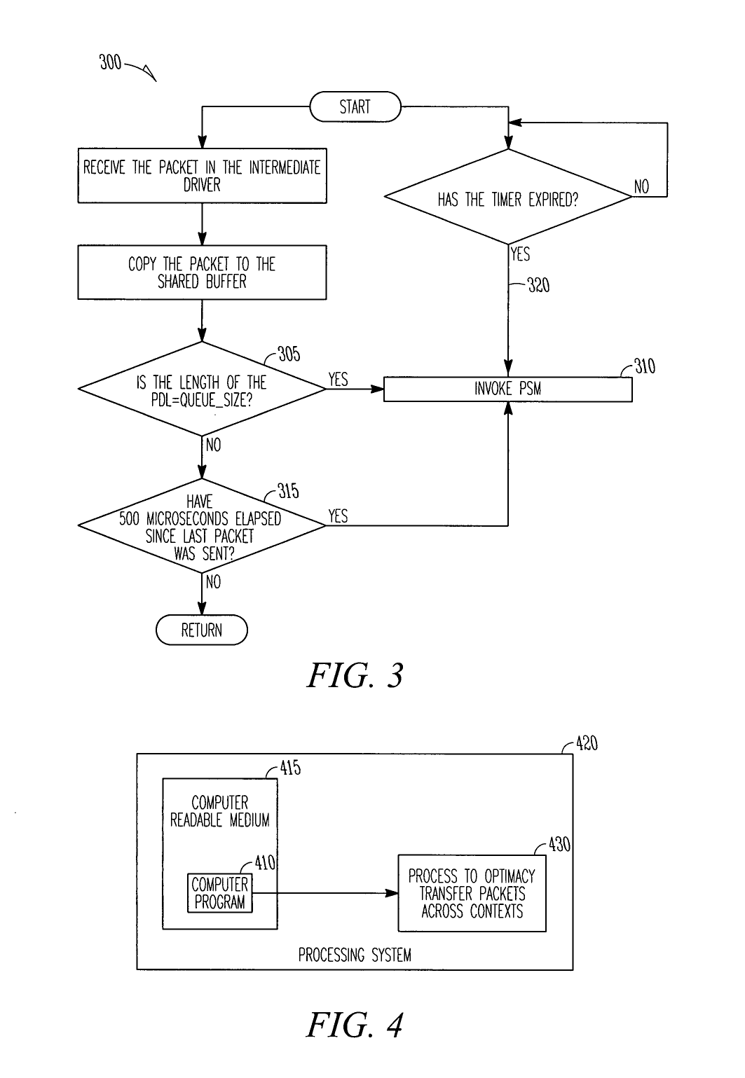

In one example embodiment, illustrated in the flow diagram 300 of FIG. 3, there are three Triggers (Trigger 1, Trigger 2 and Trigger 3) that make the PSM 215 send the packet on to the wire, as now described. Packets are received 302 in the intermediate driver and copied 304 to the shared buffer.

Trigger 1 (Packet Count): If 305 the queue reaches QUEUE_SIZE, the PSM 215 is triggered 310 and all the packets in the queue are validated and sent out on the wire. In order to be able to empty the queue while still filling it with more packets simultaneously, the head of the queue is cached and the original head of the queue is made null. In this way more packets can be added to the head of the queue even when the older packets have not been cleared.

Trigger 2 (Time since Last Packet): Using the PSF 205 module, the time difference between the current time and the time when PSM 215 was last fired is measured. If 315 the PSM 215 has not been fired in last N microseconds, for example 500 microseconds, the PSM 215 is fired 310 which subsequently clears all the packets from the queue. This trigger might not be fired for more than N microseconds as it is dependent on the PSF 205 which is fired once per packet. So in theory, if there are no more packets, the PSM 215 may not get fired until the size of the queue is QUEUE_SIZE

Trigger 3 (Absolute Time): In order to handle the above problem a timer is triggered 320 at every millisecond interval. This timer in turn invokes 310 the PSM 215. As a result, any packet is guaranteed to be on the wire in a millisecond from the time it was seen by the PSF 205. Most traffic streams are handled by the second trigger and most packets see a worst case delay of T microseconds.

According to one example, embodiment the use of the inventive subject matter may positively affects VMExits per packet and the CPU utilization. In addition, as the network throughput increases, the CPU utilization overhead imposed by the queuing solution may go down. In fact, at throughput of 300 Mbps, the queuing solution may, in at least some cases, utilize less CPU than the bare virtualization solution that provides no protections. This can be attributed to the fact the queuing solution, in general, may reduce the number of interrupts generated by the network traffic, and hence causes fewer VMExits. These numbers directly translate to more available CPU power to the commodity operating system, and improved battery life on mobile platforms.

According to one example embodiment, there is provided an event and timer based mechanism to minimize the number of VMExits for every packet. In the NIC driver, the packet buffers are copied into contiguous memory area that is page aligned. This memory area is pre-shared between the protected and the unprotected sections. The protected section code, executed on triggers, takes the bunch of packets in the pre shared memory area, validates them and sends them out on the wire. This approach reduces the average number of VM Exits incurred for every packet with an average latency of, in at least some implementations, less than 500 microseconds, without adding any degradation in TCP throughput. According to one example embodiment, the inventive subject matter is employed on both fixed and mobile platforms.

Thus, according to one example embodiment of the inventive subject matter, the CPU utilization penalty for use of VT based protection is reduced by a significant factor, and protection may be afforded for protecting privileged software agents, and detecting Rootkits and malware. In addition, throughput for network software agents utilizing VT based protections may be increased by reducing VMExits. Further, the reduced CPU utilization and VMExits may translate to lower power consumption and increased battery life especially significant for mobile platforms. Still further, the technology may allow for efficiently protecting Guest OS components of critical software without losing performance. In addition, the mechanism/algorithm used according to one example embodiment of the inventive subject matter is independent of the operating system (OS). Moreover, according to one example embodiment, the inventive subject matter allows for protecting those components of network stack that have to reside in the User operating system in Embedded IT model (e.g., VPN). According to one example embodiment, the inventive subject matter can potentially add high performance security features to any software application or platform.

According to one example embodiment illustrated in FIG. 4, a computer program 410 embodying any one of the example techniques described above may be launched from a computer-readable medium 415 in a computer-based system 420 to execute process 430 defined in the computer program 410 to reduce the number of VMExits. Various programming languages may be employed to create software programs designed to implement and perform the methods disclosed herein.

This has been a detailed description of some exemplary embodiments of the inventive subject matter(s) contained within the disclosed subject matter. Such inventive subject matter(s) may be referred to, individually and/or collectively, herein by the term “inventive subject matter” merely for convenience and without intending to limit the scope of this application to any single inventive subject matter or inventive concept if more than one is in fact disclosed. The detailed description refers to the accompanying drawings that form a part hereof and which show by way of illustration, but not of limitation, some specific embodiments of the inventive subject matter, including a preferred embodiment. These embodiments are described in sufficient detail to enable those of ordinary skill in the art to understand and implement the inventive subject matter. Other embodiments may be utilized and changes may be made without departing from the scope of the inventive subject matter. It may be possible to execute the activities described herein in an order other than the order described. And, various activities described with respect to the methods identified herein can be executed in repetitive, serial, or parallel fashion.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In the foregoing Detailed Description, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment.

It will be readily understood to those skilled in the art that various other changes in the details, material, and arrangements of the parts and method stages which have been described and illustrated in order to explain the nature of according to one example embodiment, the inventive subject matter may be made without departing from the principles and scope of the invention as expressed in the subjoined claims.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

What is claimed is:

1. A method comprising:
protecting a packet in a network stack using a protected section of an intra-partitioned system, wherein the packet traversing the network stack has to go across a boundary that separates protected and the unprotected domains of the intra-partitioned system;
intercepting one or more packets just before they enter the network stack;
collecting the one or more intercepted packets in a buffer; and
passing the packets in the buffer to the protected domain wherein the protected domain processes all packets in the buffer together, and returns them to the unprotected domain.

2. A method according to claim 1 wherein there is computer code in the protected domain that processes the packets.

3. A method according to claim 1 wherein there is computer code in the unprotected domain that processes the packets.

4. A method according to claim 1 wherein the number of traversals across the boundary separating the protected and unprotected domains is reduced.

5. A method according to claim 1 wherein a packet traversing the boundary at least some of the time leads to a page fault.

6. A method according to claim 5 further wherein the utilization of a CPU processing page faults is reduced by reducing the traversals between protected and unprotected domains.

7. A method according to claim 1 further wherein on a receive path packets may be intercepted as soon as they are copied onto a ring buffer and the set of packets is sent to an operating system stack.

8. A method according to claim 1 wherein the logic used to intercept, buffer or process packets is added to an intermediate driver that sits between the protocol stack and a network interface card driver.

9. A system comprising:
a network stack;
one or more packets;
a protected section of an intra-partitioned system;
wherein one of more of the packets go across a boundary in the network stack that separates protected and the unprotected domains of the intra-partitioned system;
at least one first software component to intercept one or more packets just before they enter the network stack;
a buffer to hold the intercepted packets;
at least one second software component to pass the packets in the buffer to the protected domain; and
at least one third software component to process the packets in the protected domain together, and return them to the unprotected domain.

10. A system according to claim 9 wherein there is computer code in the protected domain that processes the packets.

11. A system according to claim 9 wherein there is computer code in the unprotected domain that processes the packets.

12. A system according to claim 9 wherein the number of traversals across the boundary separating the protected and unprotected domains is reduced.

13. A system according to claim 9 wherein a packet traversing the boundary at least some of the time leads to a page fault generated by at least one fourth software component.

14. A system according to claim 9 further wherein on a receive path packets may be intercepted by another software component as soon as they are copied onto a ring buffer and the set of packets is sent to an operating system stack.

15. A system according to claim 9 further including an intermediate driver that sits between the protocol stack and a network interface card driver and includes logic used to intercept, buffer or process packets.
